(19) United States
(12) Patent Application Publication
(10) Pub. No.: US 2011/0233220 A1
(43) Pub. Date: Sep. 29, 2011

(54) HOUSING FOR ELECTRONIC DEVICES AND METHOD FOR MAKING THE SAME

(75) Inventors: KAI-RONG LIAO, Shenzhen City (CN); PENG-CHENG TONG, Shenzhen City (CN); PO-FENG HO, Shindian (TW); SHIH-WEI YANG, Shindian (TW)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/911,838

(22) Filed: Oct. 26, 2010

(30) Foreign Application Priority Data
Mar. 23, 2010 (CN) 201010131007.9

(51) Int. Cl. B65D 25/54; B23P 17/00

(52) U.S. Cl. 220/662; 29/527.1

(57) ABSTRACT

A housing includes a hollow sleeve, a top wall, and a cover. The top wall is integrally formed with the hollow sleeve and seals an open end of the hollow sleeve. The hollow sleeve and the top wall include an opaque first molded article and a transparent molded article. The first molded article defines a display window hole. The second molded article is formed on the first molded article and filled in the display window hole. The cover seals the other open end facing the open end which is sealed by the top wall. The present disclosure further discloses a method for making the housing.

### CROSS-REFERENCE TO RELATED APPLICATIONS

This application is one of the four related co-pending U.S. patent applications listed below. All listed applications have the same assignee and were concurrently filed herewith. The disclosure of each of the listed applications is incorporated by reference into all the other listed applications.

| Attorney | | |
|---|---|---|
| Docket No. | Title | Inventors |
| US32716 | HOUSING FOR ELECTRONIC | Liao et al. |
| | DEVICES AND METHOD FOR | |
| | MAKING THE SAME | |
| US32837 | HOUSING FOR ELECTRONIC | Liao et al. |
| | DEVICES AND METHOD FOR | |
| | MAKING THE SAME | |
| US32839 | HOUSING FOR ELECTRONIC | Liao et al. |
| | DEVICES AND METHOD FOR | |
| | MAKING THE SAME | |
| US32840 | HOUSING AND ELECTRONIC | Liao et al. |
| | DEVICE USING THE SAME | |

### BACKGROUND

1. Technical Field

The present disclosure relates to housings for electronic devices and method for making the housings.

2. Description of Related Art

Typically, an electronic device housing includes a number of portions. The portions can be assembled together with latching members. However, the structures of these housings are complicated due to the latching members, and gaps usually exist at the junctions of the portions. Therefore, dust or other contaminants may easily enter into the housing through these gaps.

Therefore, there is room for improvement within the art.

### BRIEF DESCRIPTION OF THE FIGURES

Many aspects of the housing for electronic devices and method for making the housing can be better understood with reference to the following figures. The components in the figures are not necessarily drawn to scale, the emphasis instead being placed upon clearly illustrating the principles of the housing for electronic devices and method for making the housing. Moreover, in the drawings like reference numerals designate corresponding parts throughout the several views.

FIG. 1 is an exploded view of an exemplary embodiment of a housing.

FIG. 2 is an assembled view of the housing in FIG. 1.

FIG. 3 is a cross-sectional view of the housing in FIG. 2 taken along line III-III.

FIG. 4 is a cross-sectional view of a first mold for manufacturing a first molded article.

FIG. 5 is a cross-sectional view of the first mold shown in FIG. 4, but in a closed state.

FIG. 6 is a cross-sectional view of a moldable plastic injected into the first mold shown in FIG. 5.

FIG. 7 is a cross-sectional view of the first molded article placed into a second mold.

FIG. 8 is a cross-sectional view of a moldable plastic injected into the second mold shown in FIG. 7.

### DETAILED DESCRIPTION

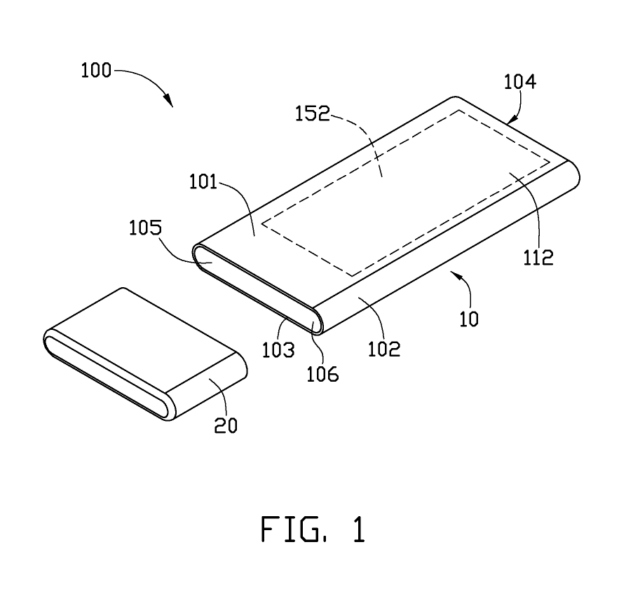

FIG. 1 shows an exemplary housing 100 used in an electronic device, such as a mobile phone, or a personal digital assistant. The housing 100 includes a main body 10 and a cover 20 connecting the main body 10.

The main body 10 may be a hollow sleeve, and includes a first sidewall 101, a second sidewall 103 opposite to the first sidewall 101, two connecting walls 102 connecting the first sidewall 101 to the second sidewall 103, and a top wall 104. The first sidewall 101, the connecting walls 102, the second sidewall 103, and the top wall 104 are integrally formed with each other and cooperatively define a receiving chamber 105. The main body 10 defines an open end 106 opening the receiving chamber 105. The receiving chamber 105 receives an electronic module (not shown).

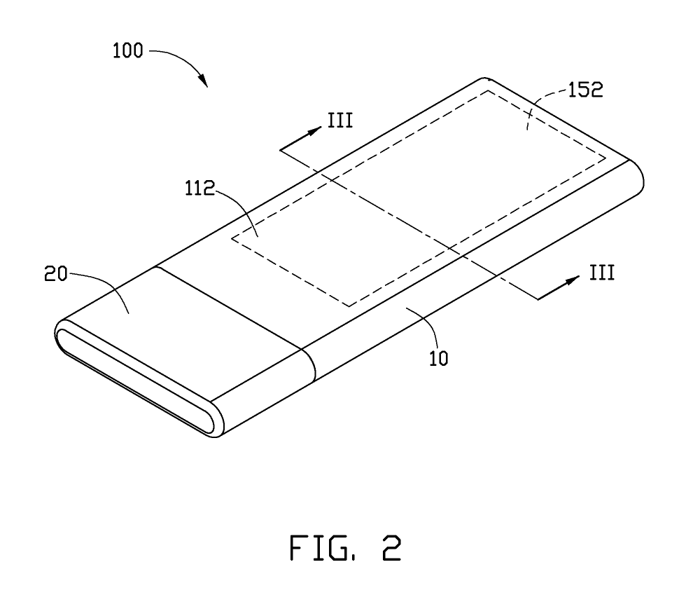

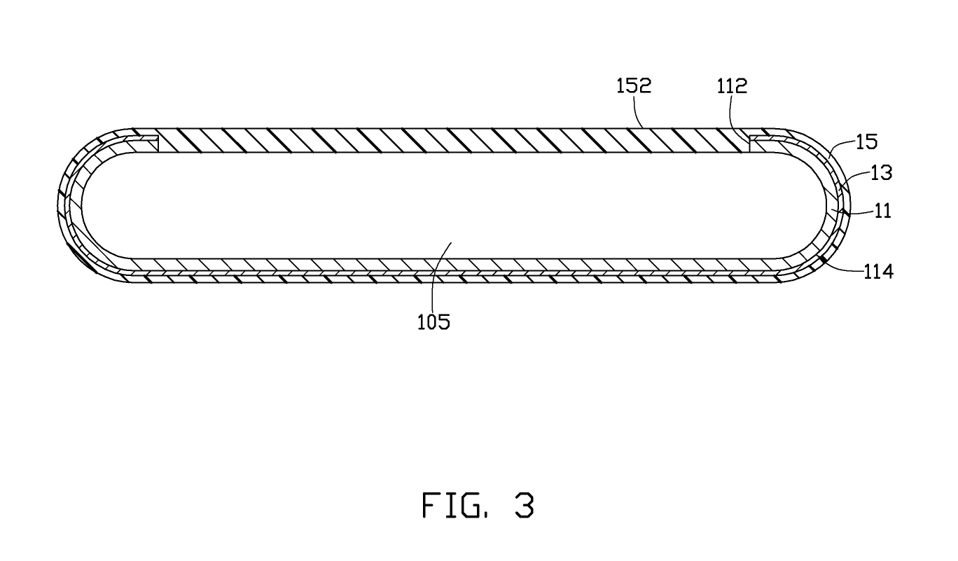

Referring to FIG. 2 and FIG. 3, the main body 10 further includes a first molded article 11, a decorative layer 13, and a second molded article 15. The first molded article 11 may be made of an opaque moldable plastic. The opaque moldable plastic may be one or more thermoplastic materials selected from a group consisting of polycarbonate (PC), acrylonitrile-butadiene-styrene (ABS), polymethyl methacrylate (PMMA), butylene terephthalate (PBT), and phenylene sulfide (PPS). A display window hole 112 is defined in the first sidewall 101, and communicates with the receiving chamber 105.

The decorative layer 13 is formed on an outer surface 114 of the first molded article 11. The decorative layer 13 may be made of ink, paint, or metal coating. The metal coating can be a non-conductive vacuum coating.

The second molded article 15 is formed on the decorative layer 13 and filled in the display window hole 112. Thus, a transparent window 152 is formed in the display window hole 112. The second molded article 15 may be made of a transparent moldable plastic. The transparent moldable plastic may be one or more thermoplastic materials selected from a group consisting of polycarbonate, acrylonitrile-butadiene-styrene, polymethyl methacrylate), butylene terephthalate, and phenylene sulfide.

The cover 20 may be made of plastic or metal, and seals to the open end 106, such as by adhesive.

An exemplary embodiment of a method for making the housing 100 may include the following steps:

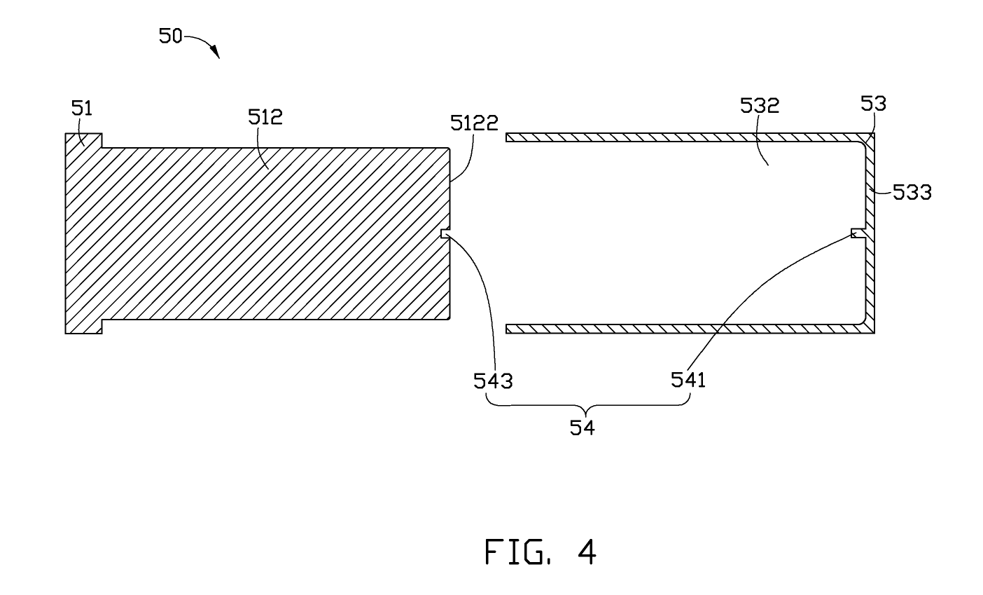

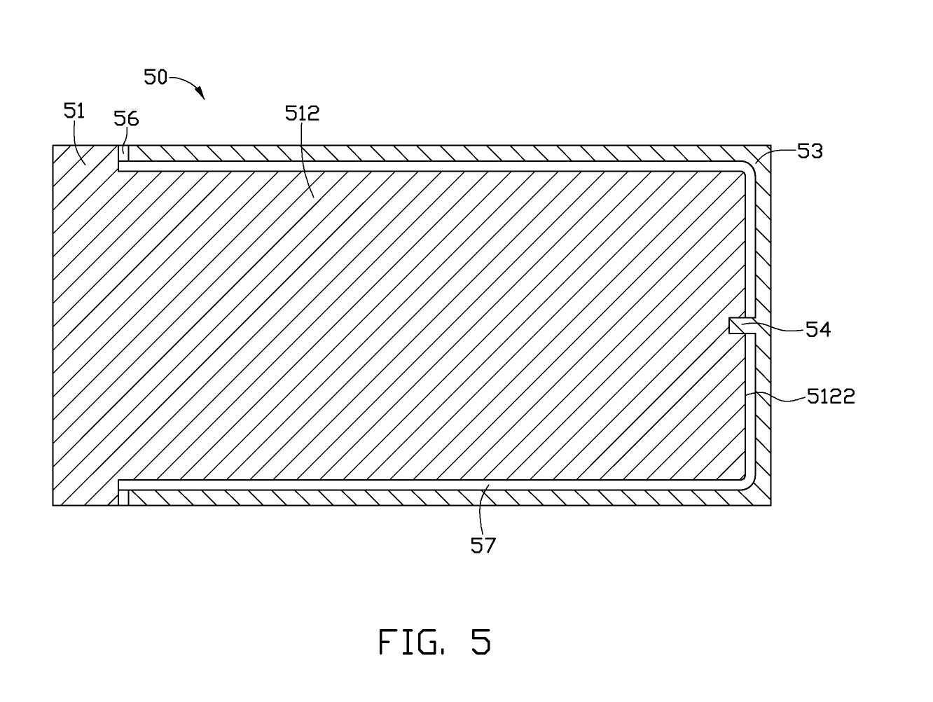

Referring to FIG. 4 and FIG. 5, a first mold 50 is provided. The first mold 50 includes a first core 51, a first cavity 53 matching with the first core 51, and a first positioning mechanism 54. The first core 51 includes a first protrusion512 protruding therefrom. The first protrusion512 has a first top portion 5122 facing the first cavity 53.

The first cavity 53 define a first recess 532. When the first mold 50 is to be closed, the first protrusion512 is received in the first recess 532 to define a first mold chamber 57. The first positioning mechanism 54 includes a first positioning post 541 and a first hole 543 receiving the first positioning post 541. The first positioning post 541 is mounted on the bottom portion 533 of the first cavity 53 opposing the first top portion 5122. The first hole 543 is defined in the first top portion 5122. The first mold 50 includes at least two first gates 56 defined between the first core 51 and the first cavity 53 when the first mold 50 is closed. When the first mold 50 is closed, the first positioning post 541 is inserted into the first hole 543 to prevent the first protrusion512 deviating from the first cavity 53.

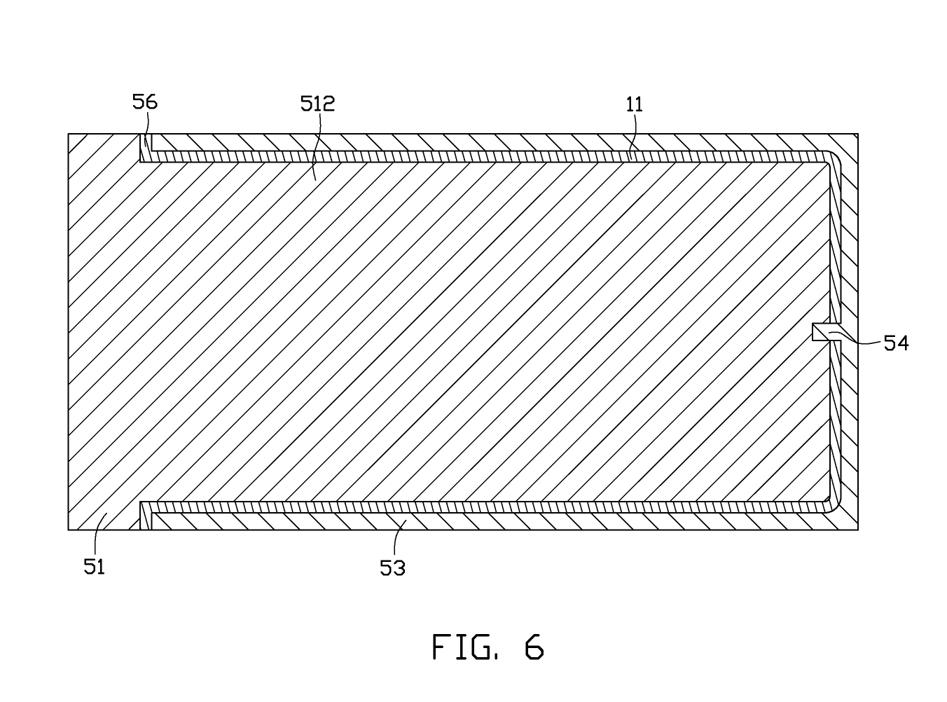

Referring to FIG. 6, the opaque moldable plastic is injected into the first mold chamber 57 from the gates 56 to form the first molded article 11. After cooling, the first molded article 11 is taken out of the first mole 50. Then, the display window hole 112 is defined in the first sidewall 101 by cutting process. The decorative layer 13 is coated on the outer surface 114 of the first molded article 11. In the exemplary embodiment, the decorative layer 13 is a non-conductive vacuum coating.

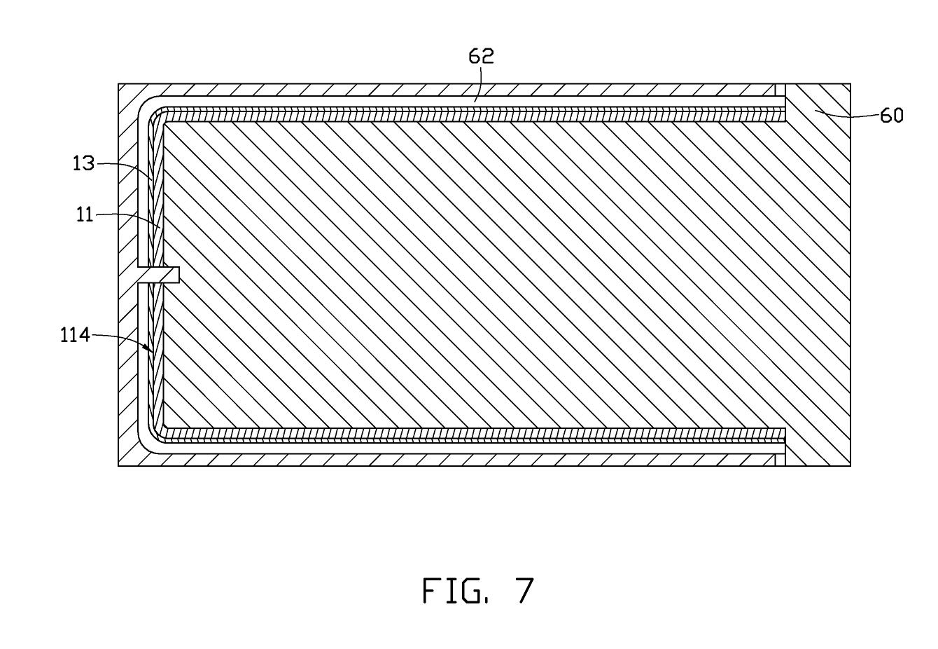

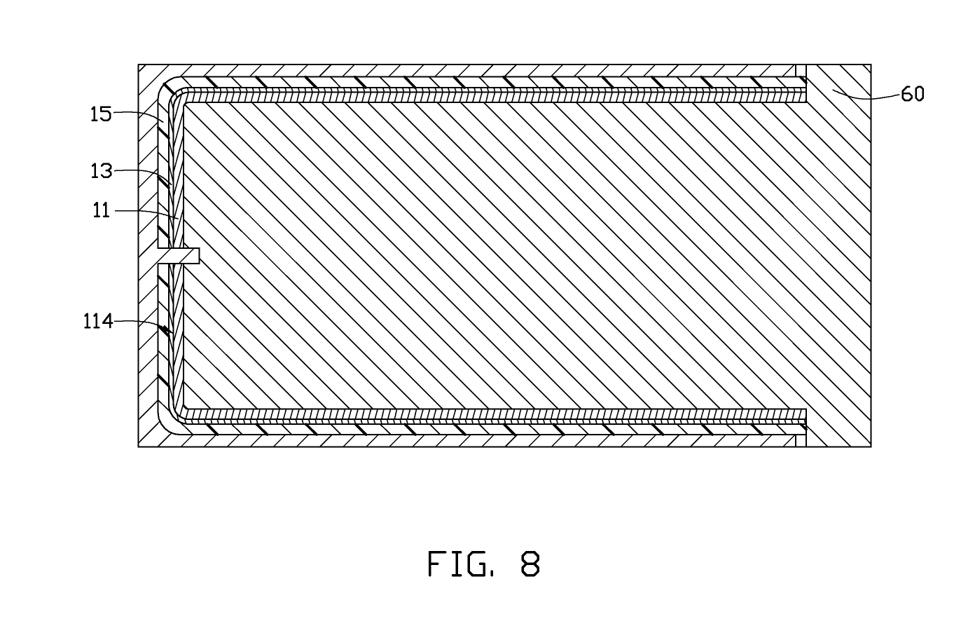

Referring to FIG. 7 and FIG. 8, a second mold 60 is provided. The second mold 60 has the same structure as the first mold 50 except a second mold chamber 62. The second mold chamber 62 has the same configuration as the main body 10. The first molded article 11 with the decorative layer 13 is placed into the second mold chamber 62. The transparent moldable plastic is injected into the second mold chamber 62 to form the second molded article 15. The second molded article 15 is filled in the display window hole 112 to form the transparent window 152. In addition, the second molded article 15 combines with the first molded article 11 and the decorative layer 13 to form the main body 10. The decorative layer 13 is sandwiched between the first molded article 11 and the second molded article 15. After cooling, the main body 10 is taken out of the second mold 60. The cover 20 seals to the open end 106 by the adhesive to form the housing 100.

In other exemplary embodiments, the first hole 543 can be defined in the first cavity 53. Correspondingly, the first positioning post 541 is mounted on the first top portion 5122.

In other exemplary embodiments, the decorative layer 13 can be omitted when the first molded article 11 has the required color. Thus, the second molded article 15 is directly connected to the first molded article 11.

In other exemplary embodiments, the decorative layer 13 also can be coated by a transparent protective layer to prevent the decorative layer 13 being scratched. The transparent protective layer is sandwiched between the decorative layer 13 and the first molded article 11

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A housing, comprising:
a main body defining a receiving chamber and an open end communicating with the receiving chamber; the main body comprising:
an opaque first molded article defining a display window hole;
a transparent second molded article formed on an outer surface of the first molded article, and the transparent second molded article filled in the display window hole; and
a cover sealing the open end.

2. The housing as claimed in claim 1, wherein the main body comprises a first sidewall, a second sidewall opposite to the first sidewall, two connecting walls connecting the first sidewall to the second sidewall, and a top wall; the first sidewall, the second sidewall, the connecting walls, and the top wall cooperatively define the receiving chamber and the open end.

3. The housing as claimed in claim 1, wherein the housing comprises a decorative layer sandwiched between the first molded article and the second molded article.

4. The housing as claimed in claim 3, wherein the decorative layer is coated by a transparent protective layer, the transparent protective layer is sandwiched between the first molded article and the decorative layer.

5. The housing as claimed in claim 3, wherein the decorative layer is made of ink, paint, or metal coating.

6. A housing, comprising:
a hollow sleeve;
a top wall integrally formed with the hollow sleeve, the top wall sealing an end of the hollow sleeve to define a receiving chamber, and an open end formed at an opposite end of the top wall; the open end communicating with the receiving chamber; the hollow sleeve and the top wall comprising
an opaque first molded article defining a display window hole;
a transparent second molded article formed on the first molded article, and the transparent second molded article filled in the display window hole; and
a cover sealing the open end.

7. The housing as claimed in claim 6, wherein the hollow sleeve comprises a first sidewall, a second sidewall opposite to the first sidewall, two connecting walls connecting the first sidewall to the second sidewall, and the top wall; the first sidewall, the second sidewall, the connecting walls, and the top wall cooperatively define the receiving chamber and the open end.

8. The housing as claimed in claim 6, wherein the housing comprises a decorative layer sandwiched between the first molded article and the second molded article.

9. The housing as claimed in claim 8, wherein the housing comprises a transparent protective layer attached to the decorative layer, the transparent protective layer is sandwiched between the first molded article and the decorative layer.

10. The housing as claimed in claim 8, wherein the decorative layer is made of ink, paint, or metal coating.

11. A method for making a housing, comprising:
injecting an opaque moldable plastic into a first mold to form a first molded article, the first molded article defining a display window hole; a receiving chamber and an open end communicating with the receiving chamber;
placing the first molded article into a second mold and injecting a transparent moldable plastic into the second mold to form a second molded article on an outer surface of the first molded article; the second molded article filled in the display window hole to form a main body; and
providing a cover sealing the open end of the main body.

12. The method for making a housing as claimed in claim 11, wherein the first mold comprises a first core, a first cavity matching with the first core, and a first positioning mechanism, the first positioning mechanism comprises a first positioning post and a first hole receiving the first positioning post; the first core defines the first hole, the first positioning post is mounted on the first cavity.

13. The method for making a housing as claimed in claim 11, wherein the first mold comprises a first core, a first cavity matching with the first core, and a first positioning mechanism, the first positioning mechanism comprises a first positioning post and a first hole receiving the first positioning post; the first cavity defines the first hole, the first positioning post is mounted on the first core.

14. The method for making a housing as claimed in claim 11, wherein before placing the first molded article into the second mold, a decorative layer is coated on the first molded article.
